(19) United States
(12) Patent Application Publication
(10) Pub. No.: US 2019/0312263 A1
(43) Pub. Date: Oct. 10, 2019

(54) CARBON ENCAPSULATED SULFUR-METAL OXIDE COMPOSITE, METHODS OF PREPARATION, AND USES THEREOF

(71) Applicant: SABIC Global Technologies B.V., Bergen op Zoom (NL)

(72) Inventors: Yunyang LIU, Thuwal (SA); Ihab N. ODEH, Sugar Land, TX (US)

(21) Appl. No.: 16/281,646

(22) Filed: Feb. 21, 2019

(51) Int. Cl. H01M 4/36; H01M 4/04; H01M 4/38; H01M 10/0525

(52) U.S. Cl. CPC H01M 4/364; H01M 4/0471; H01M 2004/021; H01M 10/0525; H01M 4/38

(57) ABSTRACT

Methods of producing a porous material having a yolk-shell structure that includes a polysulfide trapping agent are described. The porous material can include an elemental sulfur nanostructure comprised in hollow space of the interior of the porous material. The method can include heat-treating a core-shell material that includes a polysulfide trapping agent/polymer core@carbon-containing shell to produce a polysulfide trapping agent@carbon-containing porous shell. The polysulfide trapping agent@carbon-containing porous shell can be impregnated with sulfur to form a sulfur@ polysulfide trapping agent@carbon-containing porous shell composite.

### CROSS REFERENCE TO RELATED APPLICATIONS

None.

### BACKGROUND OF THE INVENTION

### A. Field of the Invention

The invention generally concerns methods of producing a porous material having a core-shell or yolk-shell structure that includes a polysulfide trapping agent. The porous material can include an elemental sulfur nanostructure comprised in hollow space of the interior of the porous material.

### B. Description of Related Art

The increasing energy demand and environmental concerns have caused a need for environmentally friendly energy storage systems that are safe and low cost and have high energy densities. To meet this need, lithium-sulfur (Li-S) batteries have been developed as they (1) have a high theoretical capacity of 1672 mAh g⁻¹, which is over 5 times that of currently used transition metal oxide cathode materials, (2) are relatively inexpensive to manufacture due to abundant resources of sulfur, and (3) have nonpoisonous and environmentally benign characteristics. However, the practical application of Li-S battery cells is still limited by the following drawbacks: (1) poor electrical conductivity of sulfur (5×10⁻³⁰ S cm⁻¹ ) limits the utilization efficiency of active material and rate capability; (2) high solubility of polysulfide intermediates in the electrolyte results in a shuttling effect in the charge-discharge process; and (3) large volumetric expansion (about 80%) during charge and discharge, which results in rapid capacity decay and low Coulombic efficiency.

The high capacity and cycling ability of sulfur can arise from the electrochemical cleavage and re-formation of sulfur-sulfur bonds in the cathode, which, without wishing to be bound by theory, is believed to proceed in two steps. First, the reduction of sulfur to lithium higher polysulfides (Li₂Sₙ where 4≤n≤8) is followed by further reduction to lithium lower polysulfides (Li₂Sₙ where 1≤n≤3). The higher polysulfides can be dissolved into an organic liquid electrolyte, enabling them to penetrate through a polymer separator between the anode and cathode, and then react with the lithium metal anode, leading to the loss of sulfur active materials. Even if some of the dissolved polysulfides diffuse back to the cathode during the recharge process, the sulfur particles formed on the surface of the cathode are electrochemically inactive owing to the poor conductivity. Such a degradation path leads to poor capacity retention, especially during long cycling (e.g., more than 100 cycles).

Various attempts to improve the capacity and the conductivity of Li-S devices, while preventing polysulfide dissolution and shuttling, have been disclosed. By way of example, Seh et al. (Nat Commun 2013, 4:1331) describes the use of sulfur@TiO₂ yolk-shell nanoparticles, in a cathode for Li-S batteries to address polysulfide dissolution. In another example, U.S. Patent Application Publication No. 2015/0221935 to Zhou et al. describes a sulfur@carbon yolk-shell material for use in lithium-sulfur batteries or lithium ion batteries where the carbon shell is coated with a polymer. In yet another example, International Application Publication No. WO 2015/174931 to Ding et al., describes a porous particle that includes an electrically conductive continuous shell (e.g., graphite, graphene, carbon nanotubes or amorphous carbon) that encapsulates a core capable of reversibly reducing in the presence of a cation or anion (e.g., phosphorus, arsenic, antimony, sulfur, selenium, tellurium and polonium).

Other attempts to improve the capacity and the conductivity of Li-S devices concern controlling the deposition of the discharge product Li₂S, which is an ionic and electronic insulator. By way of example, Tao et al. (Nat. Commun., 2016, 5) describes Li₂S bound to metal oxide/carbon supports where the metal oxides have been anchored on the carbon using biotemplating methods. In yet another example, U.S. Patent Application Publication No. 2015/0056507 to Dadheech et al. describes a metal oxide/carbon coating that encapsulates sulfur-based particles.

A further attempt to improve the capacity and the conductivity of Li-S devices involves using Li₂S as a starting cathode material, which can undergo volumetric contraction instead of expansion. By way of example, She et al. (Nat. Commun., 2014, 5) describes two-dimensional layered transition metal disulfides for encapsulation of lithium sulfide cathodes.

Despite all of the currently available attempts to improve the capacity and the conductivity of Li-S materials, many of these materials suffer from capacity degradation during charge-discharge cycles. Further, the continuous expansion/de-expansion cycle during lithiation and delithiation leads to formation of polysulfides and ultimately battery failure. In addition, these materials have potential for cell, battery system, and pack instability due to volumetric stress and possible risk to dimensional integrity/stability of the energy storage device. Such risks can lead to unplanned thermal issues and create safety hazards.

In an attempt to address these problems, International Patent Publication No. WO 2018129173 to Liu et al. describes a porous material having a yolk-shell structure that includes a polysulfide trapping agent and an elemental sulfur nanostructure yolk. The process includes dispersing elemental sulfur precursor materials (e.g., ZnS), graphene material (e.g., graphene oxide), and a carbon-containing organic polymer in a polar solvent (e.g., dimethylformamide) and subjecting the dispersion conditions to the porous material.

While various attempts have been made to produce sulfur containing materials for energy devices, they can be inefficient and/or cost intensive.

### SUMMARY OF THE INVENTION

A solution to at least some of the problems associated with the formation of polysulfides in a Li-S material has been discovered. The solution lies in the addition of a polysulfide trapping agent to a porous material having a yolk-shell or core-shell structure. The yolk or core can be an elemental sulfur nanostructure(s) encapsulated in a carbon-containing porous shell. The polysulfide trapping agent can be embedded in the shell, in contact with the interior surface of the carbon-containing porous shell, included in the hollow space, and/or in contact with the elemental sulfur nanostructure, or any combination thereof. This combination of materials results in a porous material that allows for expansion of the sulfur nanostructures and capture of any produced polysulfides, specifically, higher order lithium polysulfides where 4≤n≤8), while providing increased cyclability. Furthermore, the yolk-shell or core-shell materials can be formed into a honeycomb structure, which can provide improved mechanical strength. The porous materials are suitable for use in electronic devices such as energy devices (e.g., lithium batteries, capacitors, supercapacitors and the like, preferably a lithium-sulfur secondary battery). In one instance, the porous materials can be used as an electrode (anode or cathode, preferably cathode) or as a component of an electrode in electronic devices.

In one aspect of the present invention, methods of making the porous material of the present invention are described. A method can include (a) obtaining a core-shell material comprising a polysulfide trapping agent/polymer core and a carbon-containing shell encompassing the core, (b) heat-treating the core-shell material to form a carbon-containing porous shell and a polysulfide trapping agent yolk; and (c) impregnating the yolk-porous shell material with sulfur to form a sulfur/polysulfide trapping agent/core-shell or yolk-shell material. The sulfur can be an elemental sulfur nanostructure, preferably included in a hollow portion of the carbon-containing porous shell (e.g. void space of the shell). The polysulfide trapping agent yolk can be in contact with the interior surface of the carbon-containing porous shell, in contact with the sulfur, or both. Core-shell material of step (a) can be obtained by (i) obtaining a mixture containing the polysulfide trapping agent material and a polymer-precursor templating agent, (ii) forming the polysulfide trapping agent/polymer core and dispersing the polysulfide trapping agent in the polymer core, and (iii) forming the carbon-containing shell around the polysulfide trapping agent/polymer core. The polysulfide trapping agent/polymer core can include polystyrene, cross-linked polystyrene, poly(acrylic acid), polyacrylates, poly(methyl acrylate) or any combination thereof. The carbon-containing shell encompassing the core in step (a) can include an organic polymer (e.g., polyacrylonitrile, polydopamine, polyalkylene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof, preferably polydopamine). The step (c) impregnation can include mixing the yolk-porous shell material with elemental sulfur nanomaterial and heating the mixture at 125° C. to 175° C., preferably about 155° C., under pressure. In some embodiments, the sulfur can be removed from the outer surface of the porous shell by heating the porous shell material, preferably to 75° C. to 125° C. or about 100° C. Polysulfide trapping agent(s) can include a metal oxide (e.g., MgO, Al₂O₃, CeO₂, MoO₂, MoO₃, CoO₂, Co₂O₃, La₂O₃, SnO₂, Ti₄O₇, TiO₂, MnO₂, Mn₂O₃ or CaO, or any combination thereof, preferably TiO₂). Heat-treating of step (b) can remove at least a portion of or all of the polymer from the core. In some embodiments, the polysulfide trapping agent yolk can include one or more particles of the polysulfide trapping agent.

In a particular aspect of the invention, a porous material having a yolk-shell structure is described. The porous material can include an elemental sulfur nanostructure, a carbon-containing porous shell with an exterior surface and an interior surface that defines and encloses a hollow space within the interior of the shell, and a polysulfide trapping agent. The elemental sulfur nanostructure can be comprised in the hollow space of the carbon-containing porous shell. The polysulfide trapping agent can be a metal oxide. Non-limiting examples of metal oxides include MgO, Al₂O₃, CeO₂, MoO₂, MoO₃, CoO₂, Co₂O₃, La₂O₃, SnO₂, Ti₄O₇, TiO₂, MnO₂, Mn₂O₃ or CaO, or any combination thereof. In a particular aspect, Al₂O₃ and/or TiO₂ can be used as the polysulfide trapping agent. The polysulfide trapping agent can be embedded in the carbon-containing porous shell, in contact with the interior surface of the carbon-containing porous shell, comprised in the hollow space, and/or in contact with the elemental sulfur nanostructure, or any combination thereof. In a particular aspect, the polysulfide trapping agent is comprised in the hollow space and/or in contact with the elemental sulfur nanostructure. The porous carbon-containing material of the present invention can be formed into a honeycomb structure such that the material includes a plurality of hollow spaces within the interior of the shell and a plurality of the elemental sulfur nanostructures. Each of the hollow spaces can include the elemental sulfur nanostructure.

Embodiments of the present invention include electronic devices that include the porous material of the present invention. The electronic device can be a secondary battery (e.g. rechargeable battery), a capacitor, or a supercapacitor having the porous material comprised in an electrode of the device. The electrode can be the anode or cathode of the device. In certain instances, it is the cathode. The rechargeable battery can be a lithium-ion or lithium-sulfur battery. Electronic devices can include energy storage devices.

In the context of the present invention 20 embodiments are described. Embodiment 1 is a method of making a porous material, the method comprising: (a) obtaining a core-shell material comprising a polysulfide trapping agent/polymer core and a carbon-containing shell encompassing the core; (b) heat-treating the core-shell material to form a carbon-containing porous shell and a polysulfide trapping agent yolk; and (c) impregnating the yolk-porous shell material with sulfur to form a sulfur/polysulfide trapping agent/core-shell or yolk-shell material. Embodiment 2 is the method of embodiment 1, wherein the sulfur is an elemental sulfur nanostructure, preferably in a hollow portion of the carbon-containing porous shell. Embodiment 3 is the method of any one of embodiments 1 to 2, wherein the polysulfide trapping agent yolk is in contact with the interior surface of the carbon-containing porous shell, in contact with the sulfur, or both. Embodiment 4 is the method of any one of embodiments 1 to 3, wherein the core-shell material in step (a) is obtained by: (i) obtaining a mixture comprising the polysulfide trapping agent material and a polymer-precursor templating agent; (ii) forming the polysulfide trapping agent/polymer core, wherein the polysulfide trapping agent is dispersed in the polymer core; and (iii) forming the carbon-containing shell around the polysulfide trapping agent/polymer core. Embodiment 5 is the method of any one of embodiments 1 to 4, wherein the polysulfide trapping agent/polymer core comprises polystyrene, cross-linked polystyrene, poly(acrylic acid), polyacrylates, poly(methyl acrylate) or any combination thereof. Embodiment 6 is the method of any one of embodiments 1 to 5, wherein the carbon-containing shell encompassing the core in step (a) comprises an organic polymer. Embodiment 7 is the method of embodiment 6, wherein the organic polymer is polyacrylonitrile, polydopamine, polyalkylene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof, preferably polydopamine. Embodiment 8 is the method of any one of embodiments 1 to 7, wherein impregnation of step (c) comprises mixing the yolk-porous shell material with elemental sulfur nanomaterial and heating the mixture at 125° C. to 175° C., preferably about 155° C., under pressure. Embodiment 9 is the method of any one of embodiments 1 to 8, further comprising removing sulfur from the outer surface of the porous shell. Embodiment 10 is the method of embodiment 9, wherein removing the sulfur from the outer surface comprises heating the porous shell material, preferably to 75° C. to 125° C. or about 100° C. Embodiment 11 is the method of any one of embodiments 1 to 10, wherein the polysulfide trapping agent is a metal oxide. Embodiment 12 is the method of embodiment 11, wherein metal oxide comprises MgO, Al₂O₃, CeO₂, MoO₂, MoO₃, CoO₂, Co₂O₃, La₂O₃, SnO₂, Ti₄O₇, TiO₂, MnO₂, Mn₂O₃ or CaO, or any combination thereof. Embodiment 13 is the method of embodiment 12, wherein the metal oxide is TiO₂. Embodiment 14 is the method of any one of embodiments 1 to 13, wherein heat-treating of step (b) removes the polymer from the core. Embodiment 15 is the method of any one of embodiments 1 to 14, wherein the polysulfide trapping agent yolk comprises one or more particles of the polysulfide trapping agent.

Embodiment 16 is an electronic device comprising the porous material made by any one of embodiments 1 to 15. Embodiment 17 is the electronic device of embodiment 16, wherein the electronic device is an energy storage device, preferably a rechargeable battery. Embodiment 18 is the electronic device of embodiment 17, wherein the rechargeable battery is a lithium-ion battery or a lithium-sulfur battery. Embodiment 19 is the electronic device of any one of embodiments 16 to 18, wherein the porous material is comprised in an electrode of the electronic device, preferably a cathode. Embodiment 20 is an electrode comprising the porous material made by any one of embodiments 1 to 15.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

The “yolk/shell structure” phrase means that less than 50% of the surface of the “yolk” contacts the shell. The yolk/shell structure has a volume sufficient to allow for volume expansion of the yolk without deforming the porous material. The yolk can be a nano- or microstructure. A “core/shell structure” means that at least 50% of the surface of the “core” contacts the shell.

Determination of whether a core/shell or yolk/shell is present can be made by persons of ordinary skill in the art. One example is visual inspection of a transition electron microscope (TEM) or a scanning transmission electron microscope (STEM) image of a porous material of the present invention and determining whether at least 50% (core) or less (yolk) of the surface of a given nanostructure (preferably a nanoparticle) contacts the porous shell.

“Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof. “Nanoparticles” include particles having an average diameter size of 1 to 1000 nanometers.

“Microstructure” refers to an object or material in which at least one dimension of the object or material is greater than 1000 nm (e.g., greater than 1000 nm up to 5000 nm) and in which no dimension of the structure is 1000 nm or smaller. The shape of the microstructure can be of a wire, a particle, a sphere, a rod, a tetrapod, a hyper-branched structure, a tube, a cube, or mixtures thereof. “Microparticles” include particles having an average diameter size of greater than 1000 nm, preferably greater than 1000 nm to 5000 nm, or more preferably greater than 1000 nm to 10000 nm.

The phrase “higher metal polysulfides” refers to metal sulfides having a formula of MₓSₙ, where 4≤n≤8, M is a metal, and x+n balance the valence requirements of the compound. A non-limiting example of a higher metal polysulfide is Li₂Sₙ where 4≤n≤8 and x is 2.

The phrase “lower polysulfides” refers to metal sulfides having a formula of MₓSₙ where 1≤n≤3, M is a metal, and x +n balance the valence requirements of the compound. A non-limiting example of a lower metal polysulfide is Li₂Sₙ where 1≤n≤3 and x is 2.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The porous materials of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the porous materials of the present invention are their abilities to allow the movement of chemical compounds or ions between an external environment and the interior of the material, trap polysulfides and/or absorb metal ions such as lithium ions.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIGS. 1A-1B depict schematics of polysulfide trapping agent yolk-shell structures of the present invention.

FIGS. 2A-2C depict schematics of yolk-shell structures of the present invention containing sulfur and polysulfide trapping agents.

FIG. 3 depicts a schematic of a multi-yolk shell structure that includes sulfur and polysulfide trapping agents.

FIG. 4 depicts a method of the present invention to produce yolk-shell structures having sulfur and polysulfide trapping agent yolks.

FIG. 5 depicts another method of the present invention to produce sulfur and polysulfide trapping agent yolks.

While the invention is susceptible to various modifications and alternative forms, specific embodiments thereof are shown by way of example in the drawings. The drawings may not be to scale.

### DETAILED DESCRIPTION OF THE INVENTION

A discovery has been made that provides a solution to the dissolution of higher metal (e.g., lithiated) polysulfides in a Li-S material (e.g., a Li-S energy device). The solution is premised on a porous material having a sulfur yolk and carbon shell that includes a polysulfide trapping agent. This material provides several advantages over conventional Li-S materials with or without metal oxides. Advantages can include improved cyclability due to the presence of an internal void space inside the carbon shell to accommodate the volume expansion of sulfur during lithiation and/or capture of polysulfides via chemisorption by the polysulfide trapping agent. Furthermore, the yolk-shell structure can be formed into a honeycomb bulk structure to enhance the mechanical strength of the material. Even further advantages are realized when the carbon shell includes a nitrogen species. For example, a nitrogen enriched carbon shell can (1) enhance the electrochemical properties of the porous yolk-shell material, (2) provide high adsorption of sulfur, and (3) provide good mechanical strength.

These and other non-limiting aspects of the present invention are discussed in further detail in the following sections with reference to the figures.

A. Porous Material having a Yolk-Shell Structure

The porous material of the present invention can have a yolk-shell structure that includes a polysulfide trapping agent.

1. Polysulfide Trapping Agent Yolk/Carbon Shell Structure

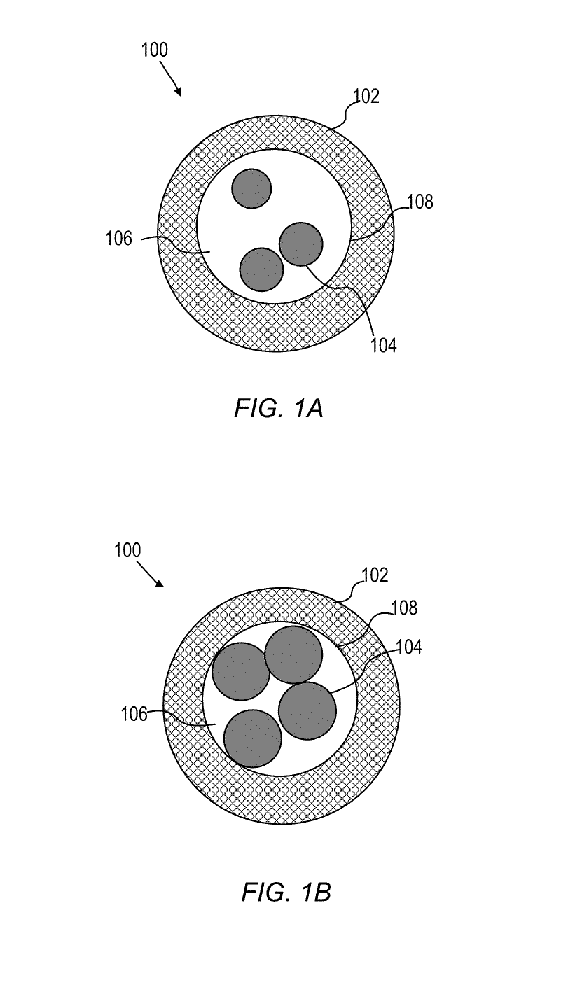

The polysulfide trapping agent yolk/porous carbon-containing shell structure of the present invention includes at least one nanostructure (or in some embodiments a plurality of nanostructures, which can be referred to as a multi-yolk-shell structure) contained within a discrete void space that is present in a carbon shell. FIGS. 1A and 1B are cross-sectional illustrations of porous material 100 having a yolk/porous carbon-containing shell structure. Porous material 100 has porous carbon-containing shell 102, polysulfide trapping agent yolks 104, and void space 106 (hollow space). As discussed in detail below, void space 106 can be formed by heat-treating the core-shell material. Wall or interior surface 108 defining void space 106 can be a portion of carbon shell 102. As shown in FIG. 1A, polysulfide trapping agents 104 does not contact shell 102. As shown in FIG. 1B, polysulfide trapping agents 104 contacts a portion of shell 102. In certain aspects, 0% to 49%, 30% to 40%, or at least greater than, equal to, or between any two of 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 36%, 37%, 38%, 39%, 40%, 41%, 42%, 43%, 44%, 45%, 46%, 47%, 48%, or 49% of the surface of polysulfide trapping agent 104 contacts shell 102. In instances where yolks 104 are particles, the diameter of the yolk 104 can range from 1 nm to 1000 nm, preferably 1 nm to 50 nm, or more preferably 1 nm to 5 nm or at least greater than, equal to, or between any two of 1, 5, 10, 25, 30, 50, 75, 100, 150, 200, 250, 300, 350, 400, 450, 500, 550, 600, 650, 700, 750, 800, 850, 900, 950, and 1000 nm. The porous carbon shell can allow movement of chemical compounds or ions between an external environment and the interior of the material.

2. Yolk/Carbon Shell and Core/Carbon Shell Structures with Sulfur

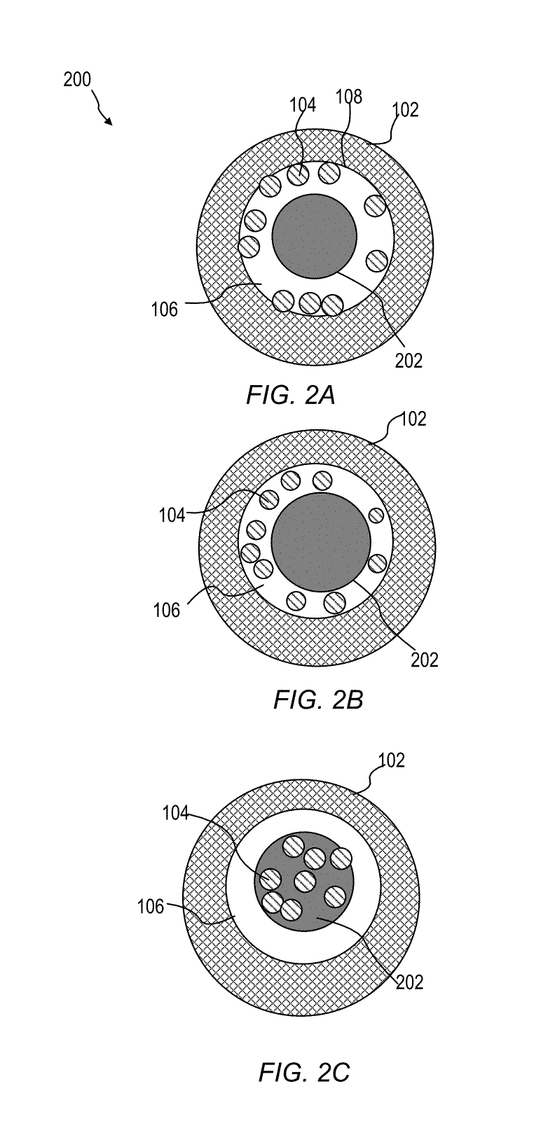

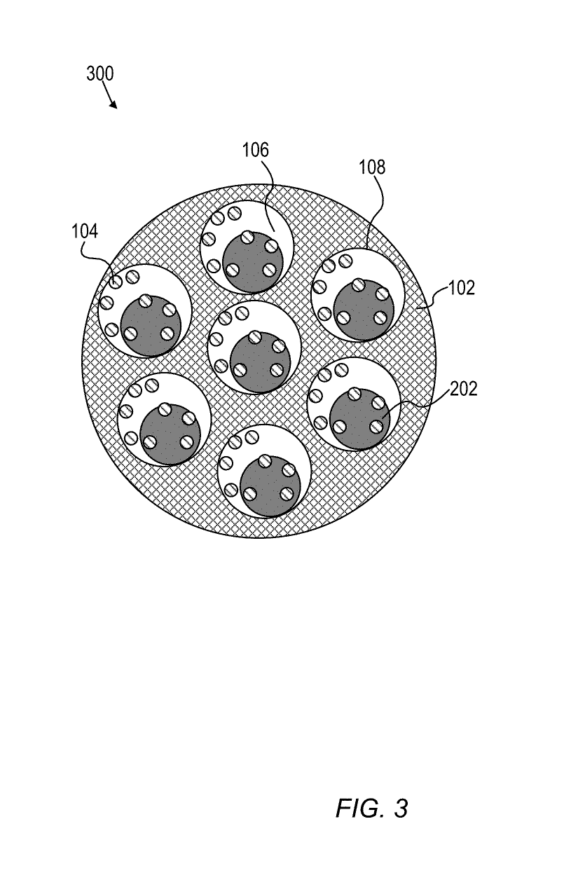

The polysulfide trapping agent yolk/porous carbon containing shell structure can include sulfur (e.g., elemental sulfur nanostructures). Sulfur, or a plurality of sulfur nanostructures, can be in contact with the interior surface of the carbon-containing porous shell, comprised in the hollow space, in contact with the elemental sulfur nanostructure, or any combination thereof. In a preferred instance, sulfur is not on the surface of the shell 102. The polysulfide trapping agent and/or sulfur can be nanostructures having a high surface area and good surface diffusion properties. Without wishing to be bound by theory, it is believed that the polysulfide trapping agent can bind polysulfides through chemisorption. By way of example, a metal polysulfide (e.g., Li₂Sₙ) can undergo a chemical reaction with the polysulfide trapping agent to bind the metal polysulfide to the surface of the polysulfide trapping agent (chemisorption). This binding can suppress the shuttle effect and enable full utilization of the active material (e.g., lithium ions and elemental sulfur). Therefore reducing the overall volumetric and weight-based energy density of the material, and the overall device. Since the polysulfide trapping agent is distributed in the hollow portion of the shell (e.g., yolk, void or interior surface), the balance between polysulfide adsorption and surface diffusion can be tuned to allow the sulfide species to deposit on the surface of the polysulfide trapping agent. This can enhance the cycling performance of the lithiation process. FIGS. 2A-2C depict the cross-sectional illustrations of porous material 200 with the polysulfide yolks 104 and carbon shell structure 100 with sulfur 202. FIG. 2A depicts polysulfide trapping agents 104 in contact with interior surface 108 and sulfur 202 of carbon-containing porous shell 102. FIG. 2B depicts polysulfide agents 104 and sulfur 202 positioned in void space 106. FIG. 2C depicts polysulfide agents 104 in contact with sulfur 202. In some embodiments, sulfur is embedded in the shell, but not on the surface of the shell. FIG. 3 depicts honeycomb structure 300 that includes porous carbon-containing shell 102, a plurality of sulfur nanostructures 202, and a plurality of polysulfide trapping agent yolks 104 in contact with the sulfur nanostructures, a plurality of void spaces 106, and a plurality of interior surfaces 108 of the porous carbon-containing shell. Compounds suitable for polysulfide trapping agents are discussed in more detail below. Both yolk/carbon shell and core/carbon shell structures with sulfur and polysulfide trapping agents are contemplated in the context of the present invention.

B. Materials

The materials or material precursors can be obtained from commercial sources, produced as described throughout the specification, or a combination of both.

1. Carbon-Containing Material Precursors

The carbon-containing shell material can be obtained from an organic precursor compound that has been subjected to condition suitable to convert the organic compound into a porous carbon-containing shell. The organic compound can be an organic polymer, a nitrogen containing organic polymer, or a blend of thereof. Non-limiting examples of organic compounds include polyacrylonitrile (PAN), polydopamine (PDA), polyalkylene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof. In a preferred embodiment, polyacrylonitrile is converted to the porous carbon-containing shell.

In the preparation of the shell material a templating material can be used, which is removed during heat-treating to form void/hollow space 106. Non-limiting examples of templating material include polystyrene, cross-linked polystyrene, poly(acrylic acid), polyacrylates, poly(methyl acrylate), or any combination thereof. In a preferred instance, polystyrene is used.

2. Elemental Sulfur

The yolk shell material includes elemental sulfur. Elemental sulfur can include, but is not limited to, all allotropes of sulfur (i.e., Sₙ, where n=1 to ∞). Non-limiting examples of sulfur allotropes include S, S₂, S₄, S₆, and S₈, with the most common allotrope being S₈.

3. Polysulfide Trapping Agents

The polysulfide trapping agents can be metal oxides. The metal portion of the metal oxide can be an alkali metal (Column 1 of the Periodic Table), alkaline earth metal (Column 2 of the Periodic Table), a transition metal (Columns 3-12 of the Periodic Table), a post transition metal (metal of Columns 13-15 of the Periodic Table), or a lanthanide metal. Non-limiting examples of metals include magnesium (Mg), aluminum (Al), cerium (Ce), lanthanum (La), molybdenum (Mo), cobalt (Co), tin (Sn), titanium (Ti), manganese (Mn), calcium (Ca), or any combination thereof. Non-limiting examples of metal oxides suitable for use in the present invention include MgO, Al₂O₃, CeO₂, MoO₂, MoO₃, CoO₂, Co₂O₃, La₂O₃, SnO₂, Ti₄O₇, TiO₂, MnO₂, Mn₂O₃ or CaO, or any combination thereof In a preferred embodiment, Al₂O₃ and/or TiO₂ is used. The metal oxide can be obtained from metal oxide precursor compounds. For example, the precursor material can be obtained as a metal hydroxide, a metal nitrate, a metal amine, a metal chloride, a metal coordination complex, a metal sulfate, a metal phosphate hydrate, metal complex, or any combination thereof. In some embodiments, the polysulfide trapping agent can be prepared by dissolving a polysulfide trapping agent precursor (e.g., Al(NO₃)₃.9H₂O) in a solvent (e.g., water) and adding a basic precipitation agent (e.g., ethylenediamine) to adjust the pH to 7 to 9, or about 8 to precipitate polysulfide trapping agent precursor (e.g., Al(OH)₃) from the solution. The polysulfide trapping agent precursor can be dried under vacuum, and then calcined at 850 to 1000° C., or about 850° C., 900° C., 950° C., or 1000° C. to convert the polysulfide trapping agent precursor material to a polysulfide trapping agent (e.g., Al(OH)₃ to Al₂O₃).

C. Preparation of the Porous Material of the Present Invention

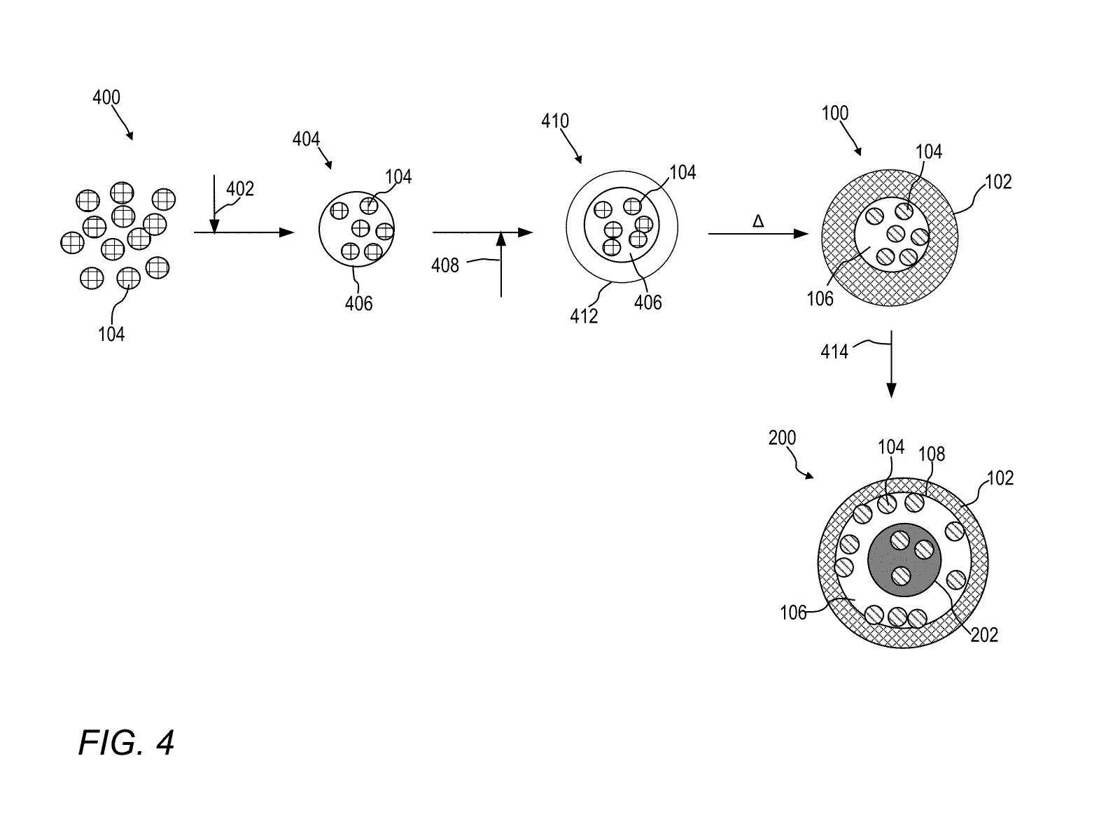

The porous material of the present invention can be made using methods described herein and methods exemplified in the Examples section. FIG. 4 depicts a method to make yolk/shell structure 200. In method 400, polysulfide trapping agent 104 (e.g., TiO₂ not shown) can be combined with polymer templating agent (e.g., styrene) 402, and then subjected to in situ polymerization conditions to produce polysulfide trapping agent precursor/ polymer material 404 having polysulfide trapping agents 104 encapsulated by removable polymer 406. The polysulfide trapping agent can include nanostructures of polysulfide trapping agent material. In embodiments a mixture of polysulfide trapping agents are used. In some embodiments, Al₂O₃ or TiO₂ nanostructures (polysulfide trapping agents), or a mixture thereof is used.

Polysulfide trapping agent/polymer material 404 can be contacted with organic polymer 408 to form core/shell structure 410 having polysulfide trapping agent/polymer material 404 core and organic polymer shell 412. Core/shell structure 410 can be subjected to heat-treating conditions sufficient to carbonize organic polymer 412 to form porous carbon shell 102 and remove polymer material 406 to form void space 106. This forms yolk/shell structure 100 where the porous carbon shell 102 encompasses polysulfide trapping agent yolks 104. For example, the core/shell structure 410 can be heat-treated to 500° C. to 1100° C., 1050° C., 1000° C., 900° C., 800° C., 700° C., or 600° C. or any range or value there between to form yolk/shell structure 100. The heat treatment can be done under an inert gas atmosphere, such as nitrogen, argon or helium. The inert gas flow can be from 50 mL/min to 1000 mL/min, 800 mL/min, 600 mL/min, 500 mL/min, 300 mL/min or 100 mL/min or any value or range there between. The pressure during heat treatment can be 0.101 MPa (atmospheric) or higher, for example 10 MPa.

The polysulfide trapping agent yolk/porous carbon shell material 100 can be contacted with sulfur 202 to allow impregnation of the sulfur material with yolk/shell material 100. The amount of sulfur can be the same or substantially the same as the volume of the hollow portion of the polysulfide trapping agent/carbon shell material. In some embodiments, the sulfur is sublimed and mixed with the yolk/shell material with grinding. The mixed material can be heat treated at a temperature of from 100° C. to 200° C., preferably 140° C. to 160° C., for 4 to 24 hours under an inert atmosphere to facilitate sulfur diffusion through the pores of the shell into the hollow portion. In some embodiments, the yolk/shell material is subjected to a vacuum prior to impregnation (e.g., 100 to 200° C. for 6 h under 10⁻⁶ bar) to facilitate sulfur diffusion through the pores into the hollow portion. Sulfur impregnation of yolk/shell material 100 forms sulfur/polysulfide trapping agent yolk/carbon shell material 200. Although not shown, a sulfur/polysulfide trapping agent core/carbon shell material 200 can be made by, for example, increasing the amount of sulfur and/or polysulfide trapping agent within the hollow space of the shell such that at least 50% of the surface of the “core” materials (sulfur and/or polysulfide trapping agent) contacts the shell surface 108.

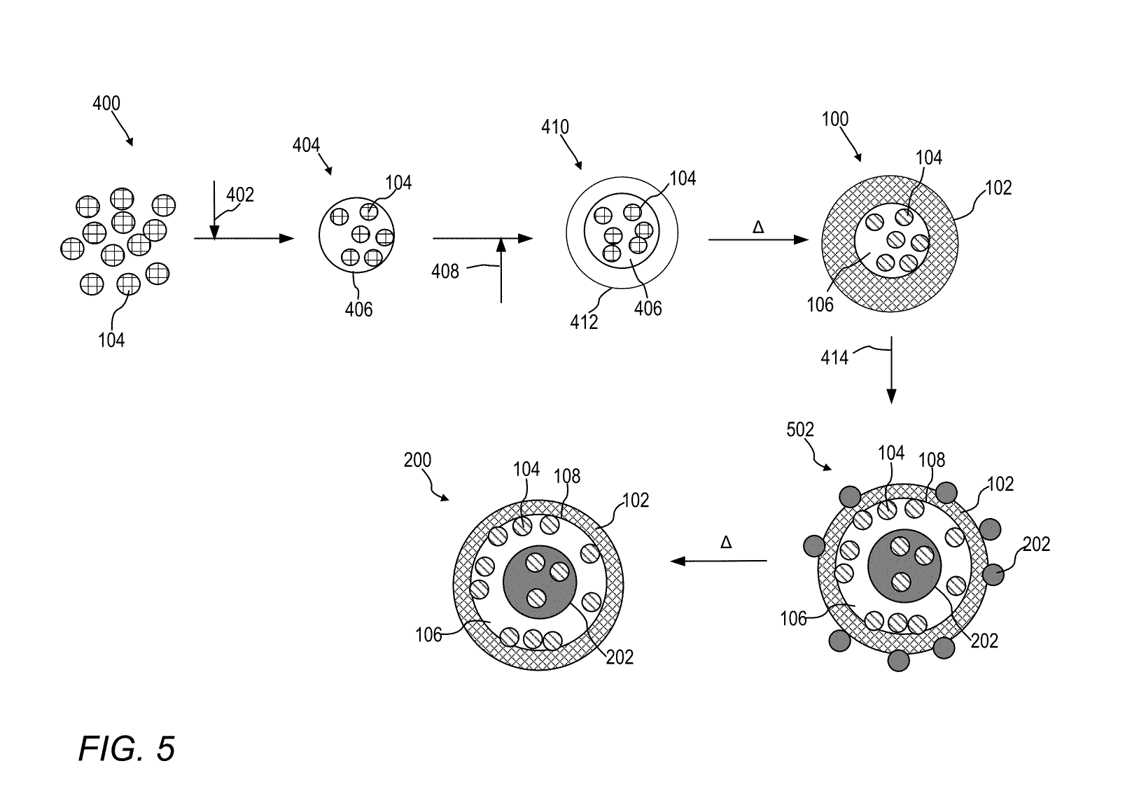

In some embodiments, sulfur remains on the outer surface of shell 102. Referring to FIG. 5, sulfur/polysulfide trapping agent yolk/carbon shell material 502 having sulfur 202 on the surface of the composite can be heated at 50° C. to 150° C., or 90 to 120° C., or about 100° C. for about 2 to 10 hours or about 3 hours to sublime the sulfur from the surface of the shell material.

D. Uses of the Porous Carbon-Containing Material with Yolk-Shell Structure

The sulfur/polysulfide trapping agent@carbon shell composites of the present invention can be used in a variety of electronic devices, energy storage applications or devices (e.g., fuel cells, batteries, supercapacitors, electrochemical capacitors, lithium-ion battery cells or any other battery cell, system or pack technology), optical applications, and/or controlled release applications. In some instances, the composites of the present invention can be used as an electrode (cathode or anode, preferably cathode) or comprised in an electrode. The term “energy storage device” can refer to any device that is capable of at least temporarily storing energy provided to the device and subsequently delivering the energy to a load. Furthermore, an energy storage device may include one or more devices connected in parallel or series in various configurations to obtain a desired storage capacity, output voltage, and/or output current. Such a combination of one or more devices may include one or more forms of stored energy. By way of example a lithium ion battery can include the previously described sulfur/polysulfide trapping agent@carbon shell composites (e.g., on an anode electrode and/or a cathode electrode). In another example, the energy storage device can include other technologies for storing energy, such as devices that store energy through performing chemical reactions (e.g., fuel cells), trapping electrical charge, storing electric fields (e.g., capacitors, variable capacitors, ultra-capacitors, and the like), and/or storing kinetic energy (e.g., rotational energy in flywheels). In some embodiments, the article of manufacture is a virtual reality device, an augmented reality device, a fixture that requires flexibility such as an adjustable mounted wireless headset and ear buds, a communication helmet with curvatures, a medical patch, a flexible identification card, a flexible sporting good, a packaging material and applications where the energy source can simply final product design, engineering and mass production.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

(Preparation of TiO₂@Polystyrene (PS) composite)

Preparation of TiO₂@PS composite: grafted TiO₂ powder (2 g, MilliporeSigma, USA) was dispersed in ethanol by Sonic Dismembrator (200 mL, Fisher Scientific, Model 550) and then polyvinylpyrrolidone (2 g, PVP, Mw=360000) was added. To this solution, AIBN (0.2 g), styrene (17.2 mL), divinylbenzene (1.4 ml) was added and mixed by ultrasonication. After bubbling nitrogen through the reaction medium for 30 min, the polymerization was carried out at 70° C. for 24 h. The white precipitation was collected by centrifuge (8000 RPM) and water with ethanol three times to remove unreacted monomer.

### Example 2

(Preparation of TiO₂@PS@Polydopamine (PDA) composite)

Preparation of TiO₂@PS@PDA composite: TiO₂@PS (2 g, Example 1) and tris(hydroxymethyl)aminomethane (1.44 g, Mw=121.14, 12 mmol) were dispersed in H₂O (300 mL) using a Sonic Dismembrator (Fisher Scientific, Model 550, 50%, 1 h). To this mixture, dopamine hydrochloride (1.2 g, Mw=189.64, 16.9 mmol) was added, and the resulting mixture stirred overnight. The resulting solid was collected via centrifugation, washed with deionized (DI) water 3 times. After dried at 60° C. overnight, a TiO₂@PS@PDA as a black powder was obtained.

### Example 3

(Preparation of TiO₂@ Carbonized PDA (CPDA) composite)

TiO₂@PS@PDA (2 g, Example 2) was loaded to a tubular furnace and heated at 600° C. at 5° C. /min under N₂ (200 CC/min) and kept for 2 h to produce TiO₂@CPDA (0.8 g) as a black powder.

### Example 4

(Preparation of S@TiO₂@ CPDA composite)

TiO₂@CPDA (0.5 g) and sublimed sulfur (1.5 g, MilliporeSigma) were mixed by grinding on a mortar. Then the mixture was loaded into a polytetrafluoroethene lined autoclave and heated at 155° C. for 12 h under N₂. Finally, the sulfur on the surface of carbon shell was removed by sublimation at 100° C. for 3 h to produce S@TiO₂@ CPDA as a black powder.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A method of making a porous material, the method comprising:
(a) obtaining a core-shell material comprising a polysulfide trapping agent/polymer core and a carbon-containing shell encompassing the core;
(b) heat-treating the core-shell material to form a carbon-containing porous shell and a polysulfide trapping agent yolk; and
(c) impregnating the yolk-porous shell material with sulfur to form a sulfur/polysulfide trapping agent/ core-shell or yolk-shell material.

2. The method of claim 1, wherein the sulfur is an elemental sulfur nanostructure, preferably in a hollow portion of the carbon-containing porous shell.

3. The method of claim 1, wherein the polysulfide trapping agent yolk is in contact with the interior surface of the carbon-containing porous shell, in contact with the sulfur, or both.

4. The method of claim 1, wherein the core-shell material in step (a) is obtained by:
obtaining a mixture comprising the polysulfide trapping agent material and a polymer-precursor templating agent;
(ii) forming the polysulfide trapping agent/polymer core, wherein the polysulfide trapping agent is dispersed in the polymer core; and
(iii) forming the carbon-containing shell around the polysulfide trapping agent/polymer core.

5. The method of claim 1, wherein the polysulfide trapping agent/polymer core comprises polystyrene, cross-linked polystyrene, poly(acrylic acid), polyacrylates, poly(methyl acrylate) or any combination thereof.

6. The method of claim 1, wherein the carbon-containing shell encompassing the core in step (a) comprises an organic polymer.

7. The method of claim 6, wherein the organic polymer is polyacrylonitrile, polydopamine, polyalkylene, polyacrylate, poly halide, polyester, polycarbonate, polyimide, phenol formaldehyde resin, epoxy, polyalkylene glycol, polysaccharide, polyethylene, polypropylene, polymethylmethacrylate, polyvinyl chloride, polyethylene terephthalate, polyethylene glycol, polypropylene glycol, starch, glycogen, cellulose, or chitin, or any combination thereof, preferably polydopamine.

8. The method of claim 1, wherein impregnation of step (c) comprises mixing the yolk-porous shell material with elemental sulfur nanomaterial and heating the mixture at 125° C. to 175° C., preferably about 155° C., under pressure.

9. The method of claim 1, further comprising removing sulfur from the outer surface of the porous shell.

10. The method of claim 9, wherein removing the sulfur from the outer surface comprises heating the porous shell material, preferably to 75° C. to 125° C. or about 100° C.

11. The method of claim 1, wherein the polysulfide trapping agent is a metal oxide.

12. The method of claim 11, wherein metal oxide comprises MgO, Al₂O₃, CeO₂, MoO₂, MoO₃, CoO₂, Co₂O₃, La₂O₃, SnO₂, Ti₄O₇, TiO₂, MnO₂, Mn₂O₃ or CaO, or any combination thereof.

13. The method of claim 12, wherein the metal oxide is TiO₂.

14. The method of claim 1, wherein heat-treating of step (b) removes the polymer from the core.

15. The method of claim 1, wherein the polysulfide trapping agent yolk comprises one or more particles of the polysulfide trapping agent.

16. An electronic device comprising the porous material made by claim 1.

17. The electronic device of claim 16, wherein the electronic device is an energy storage device, preferably a rechargeable battery.

18. The electronic device of claim 17, wherein the rechargeable battery is a lithium-ion battery or a lithium-sulfur battery.

19. The electronic device of claim 16, wherein the porous material is comprised in an electrode of the electronic device, preferably a cathode.

20. An electrode comprising the porous material made by claim 1.
